(19) United States
(12) Patent Application Publication
(10) Pub. No.: US 2002/0023142 A1
(43) Pub. Date: Feb. 21, 2002

(54) Methods and apparatus for retrieving a web site based on broadcast radio or television programming

(76) Inventors: A. John Michaelis, Balmain (AU); James L. Warmus, LaGrange, IL (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/933,514

(22) Filed: Aug. 20, 2001

Related U.S. Application Data
(60) Provisional application No. 60/226,739, filed on Aug. 21, 2000.

(51) Int. Cl. G06F 15/16

(52) U.S. Cl. 709/217

(57) ABSTRACT

The methods and apparatus described herein provide a system for determining a target web site associated with a radio or television program by making a comparison between a received sound segment and a known sound segment. The received sound segment is preferably captured at a personal computer (or any other computing device) by a microphone or a hard wired connection. The known sound segment is preferably retrieved from a plurality of known sound segments indicative of audio from a plurality of radio and/or television channels. Received sound segments and known sound segments are preferably time stamped to further facilitate comparison. This comparison may occur in the personal computer by making data indicative of the known sound segments available to the device. Alternatively, the comparison may be achieved by passing the received sound segment to another location (e.g., an Internet site). In an alternate embodiment, received video segments may be compared to known video segments. Once the comparison is performed, the channel (or station) can be determined and a target web site may be identified. Subsequently, the personal computer may be directed to an existing web page or a dynamically generated web page (e.g., based on the determined channel/station, the users viewing history, the user's geographical location, the user's voice commands, and/or the user's demographics).

### RELATED APPLICATION

This application claims priority from U.S. Provisional Application Ser. No. 60/226,739 filed Aug. 21, 2000, which is incorporated herein by reference.

### TECHNICAL FIELD

The present system relates in general to media broadcast systems and the Internet, and in particular, to methods and apparatus for downloading a web page related to a radio or television broadcast to a client device based on a comparison of broadcast audio or video to candidate audio or video files.

### BACKGROUND

As radio, television, and the Internet converge, user's require systems which more seamlessly integrate these otherwise disparate technologies. One such system employs a tone inserted into the sound channel of a television or radio program. A microphone equipped device which is also connected to the world wide web may detect the tone and automatically switch to a web site related to the programming and/or the advertising associated with the tone. Although tones are relatively easy to decode, tone broadcasts are potentially irritating to a listener.

Another system embeds a digital code into the sound channel of a television or radio program. A web connected device which is able to detect the embedded codes and is programmed to decipher the embedded codes may automatically switch to a web site related to the programming and/or the advertising associated with the embedded code. However, detecting the code may require more than just an audio microphone, and not all audio channels will necessarily include the code.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of an exemplary communications system.

FIG. 2 is a more detailed block diagram of one of the servers illustrated in FIG. 1.

FIG. 3 is a more detailed block diagram of one of the personal computers illustrated in FIG. 1.

FIG. 4 is a more detailed block diagram of one of the broadcast reception devices illustrated in FIG. 1.

FIG. 5 is a flowchart of a process for activating a web site based on audio programming.

### DETAILED DESCRIPTION OF EXEMPLARY EMBODIMENTS

In general, the system described herein determines a target web site associated with a radio or television program by making a comparison between a received sound segment and a known sound segment. The received sound segment is preferably captured at a personal computer (or any other computing device) by a microphone or a hard wired connection. The known sound segment is preferably retrieved from a plurality of known sound segments indicative of audio from a plurality of radio and/or television channels. Received sound segments and known sound segments are preferably time stamped to further facilitate comparison. This comparison may occur in the personal computer by making data indicative of the known sound segments available to the device. Alternatively, the comparison may be achieved by passing the received sound segment to another location (e.g., an Internet site). In an alternate embodiment, received video segments may be compared to known video segments. Once the comparison is performed, the channel can be determined and a target web site may be identified. Subsequently, the personal computer may be directed to an existing web page or a dynamically generated web page (e.g., based on the determined channel, the users viewing history, the user's geographical location, the user's voice commands, and/or the user's demographics). In yet another embodiment, a radio or television may be equipped to communicate the current frequency or channel that is tuned directly to the personal computer.

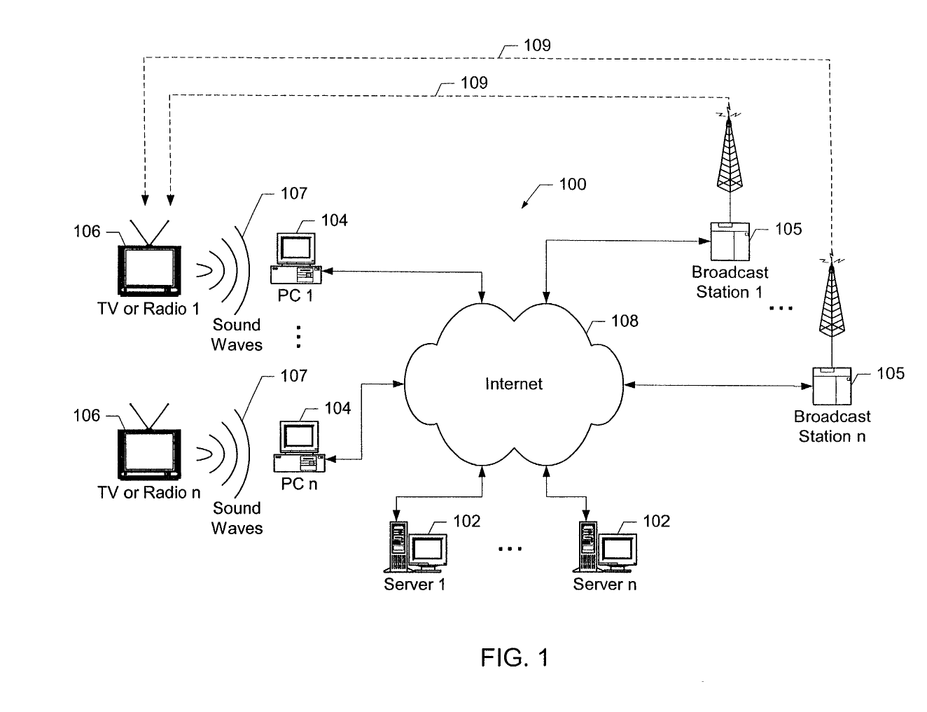

A high level block diagram of a communications system 100 providing a preferred environment of use is illustrated in FIG. 1. The system 100 includes one or more servers 102, one or more personal computers (PCs) 104, one or more broadcast stations 105, and one or more broadcast reception devices 106 (e.g., television, radio, etc.). The broadcast reception devices 106 receive broadcast signals 109, (e.g., radio, television, cable, and/or web signals) and convert the broadcast signals 109 into human perceivable sound waves 107 and/or video signals in a well known manner. The servers 102, PCs 104, and broadcast stations 105 may communicate with each other via a direct connection or connections to a wide area network 108 such as the Internet. Typically, servers 102 store a plurality of files, programs, and/or web pages for use by the PCs 104. One server 102 may handle requests from a large number of PCs 104. Accordingly, each server 102 is typically a high end computer with a large storage capacity, one or more fast microprocessors, and one or more high speed network connections. Conversely, relative to a typical server 102, each PC 104 typically includes less storage capacity, a single medium to high speed microprocessor, and a single medium speed network connection.

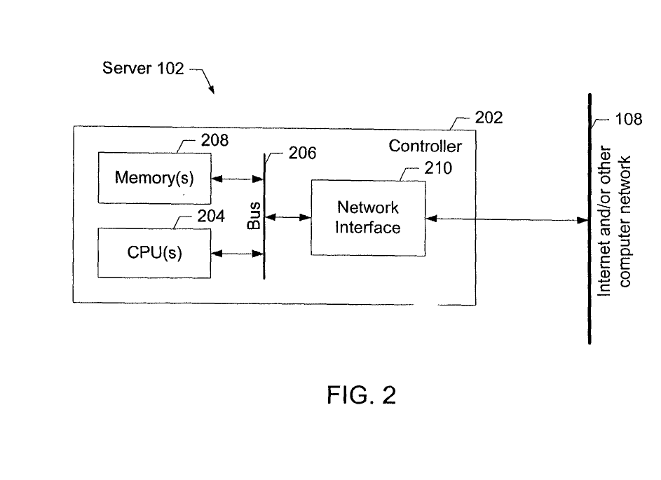

A more detailed block diagram of a server 102 is illustrated in FIG. 2. A controller 202 in the server 102 preferably includes a central processing unit 204 electrically coupled by an address/data bus 206 to a memory device 208 and a network interface circuit 210. The CPU 204 may be any type of well known CPU, such as an Intel PentiumTM processor. The memory device 208 preferably includes volatile memory, such as a random-access memory (RAM), and non-volatile memory, such as a read only memory (ROM) and/or a magnetic disk. The memory device 208 stores a software program that may implement all or part of the method described below. This program is executed by the CPU 204, as is well known. However, some of the steps described in the method below may be performed manually or without the use of the server 102. The memory device 208 also stores data, files, programs, web pages, etc. for retrieval and update by the PCs 104 and/or broadcast reception devices 106.

The server 102 may exchange data with other computing devices via a connection to the network 108. The network interface circuit 210 may be implemented using any data transceiver, such as an Ethernet transceiver. The network 108 may be any type of network, such as a local area network (LAN) and/or the Internet.

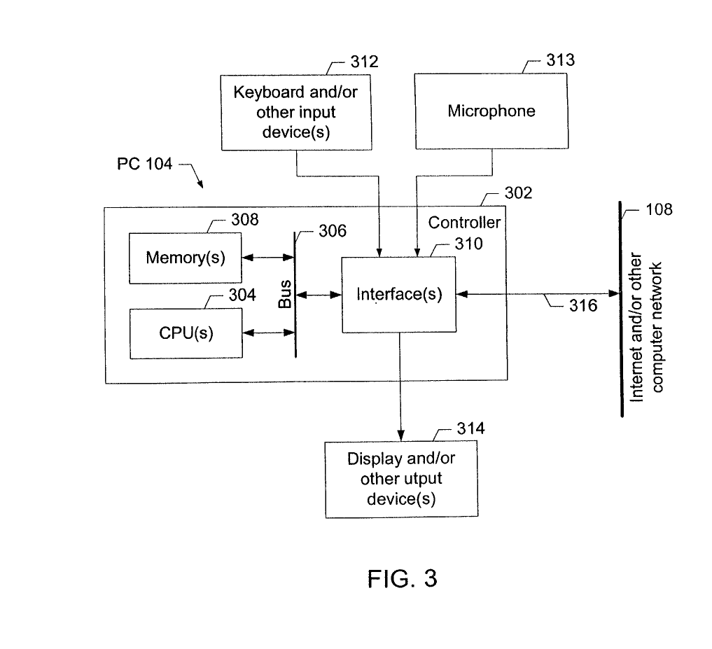

A more detailed block diagram of a PC 104 is illustrated in FIG. 3. Like the server 102, the PC 104 includes a controller 302 which preferably includes a central processing unit 304 electrically coupled by an address/data bus 306 to a memory device 308 and an interface circuit 310. Again, the CPU 304 may be any type of well known CPU, such as an Intel PentiumTM processor, and the memory device 308 preferably includes volatile memory and non-volatile memory. However, as discussed above, the CPU 304 and/or memory device 308 associated with a typical PC 104 may not be as powerful as the CPU 204 and/or memory 208 associated with a typical server 102. Like the server 102, the memory device 308 associated with the PC 104 stores a software program that may implement all or part of the method described below. This program is executed by the CPU 304, as is well known. However, some of the steps described in the method below may be performed manually or without the use of the PC 104. The memory device 308 also stores data, files, programs, web pages, etc. retrieved from a server 102 and/or transmitted by a broadcast reception device 106.

The interface circuit 310 may be implemented using any type of well known interface standard, such as an Ethernet interface and/or a Universal Serial Bus (USB) interface. One or more input devices 312 may be connected (wired or wirelessly) to the interface circuit 310 for entering data and commands into the controller 302. For example, the input device 312 may be a keyboard, mouse, touch screen, track pad, track ball, isopoint, and/or a voice recognition system.

In addition, a microphone 313 is preferably connected to the interface circuit 310. The microphone 313 captures the sound waves 107 transmitted by a broadcast reception devices 106. Captured sound waves 107 may be digitized by the PC 104 in a well known manner to produce one or more data files indicative of current audio segments of a broadcast signal. Preferably, these data files are at least temporarily stored in the PC memory 308. Of course, a person of ordinary skill in the art will readily appreciate that a wired connection between the PC 104 and the broadcast reception device 106 (e.g., an audio or video jack) would eliminate the need for the microphone 313. Like captured sound waves, captured video signals may be digitized by the PC 104 in a well known manner to produce one or more data files indicative of current video segments of a broadcast signal.

Subsequently, a data file representing the digitized sound waves or video signals may be compared to other data files representing candidate digitized audio or video signals in order to search for a match. Of course, a person of ordinary skill the art will readily appreciate that a match need not be an exact match. Preferably, the candidate digital audio files or video files are stored at least temporarily in the server memory 208. The candidate files may be transmitted from a broadcast station 105 to the server 102 via a direct connection (not shown), via the network 108, or via a broadcast reception device 106. In the event that the candidate files are transmitted from a broadcast station 105 to a server 102 via a broadcast reception device 106, the broadcast reception device 106 may be connected directly to the server 102 or communicate with the server 102 via the network 108.

The comparison may be performed at the PC 104 and/or a server 102. Accordingly, the PC 104 may transmit the captured data file to the server 102 via the network 108 to allow the server to perform the comparison, and/or the server 102 may transmit the candidate data files to the PC 104 via the network 108 to allow the PC 104 to perform the comparison.

One or more output devices 314 may also be connected to the controller 302 via the interface circuit 310. Examples of output devices 314 include cathode ray tubes (CRTs), liquid crystal displays (LCDs), speakers, and/or printers. The output device 314 generates visual displays of data generated during operation of the PC 104. The visual displays may include prompts for human operator input, run time statistics, calculated values, detected data, etc.

The PC 104 may exchange data with other computing devices via a connection 316 to the network 108 and/or a direct connection data transceiver (not shown). For example, the PC 104 and a server 102 may exchange data files as described in detail above. The network connection 316 may be any type of network connection, such as an Ethernet connection, digital subscriber line (DSL), telephone line, coaxial cable, etc. The data transceiver may be any type of data transceiver, such as an infrared transceiver, a radio transceiver, a Universal Serial Bus transceiver (USB), etc.

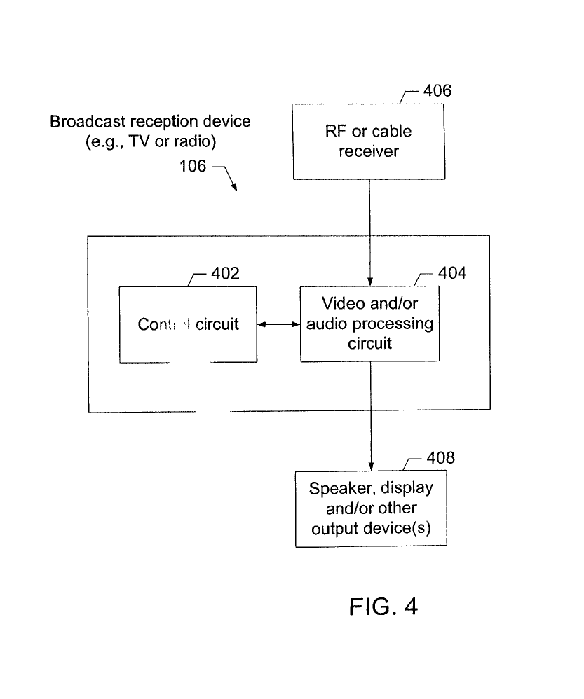

A more detailed block diagram of a broadcast reception device 106 is illustrated in FIG. 4. The broadcast reception device 106 may include a controller circuit 402 which is preferably coupled to a video and/or audio processing circuit 404. The processing circuit 404 receives broadcast signals via a receiver 406. In a preferred embodiment, the broadcast signals are television signals or radio signals. Accordingly, the receiver 406 is preferably a television or radio receiver 406. Signals may arrive at the receiver 406 via a cable, or signals may arrive at the receiver 406 wirelessly. For example, a television signal may be received over-the-air or via a coaxial cable, as is well known. Once received and processed, certain broadcast signals are converted to audio and/or video signals and presented to a user via an output device 408 such as a speaker and/or a video display.

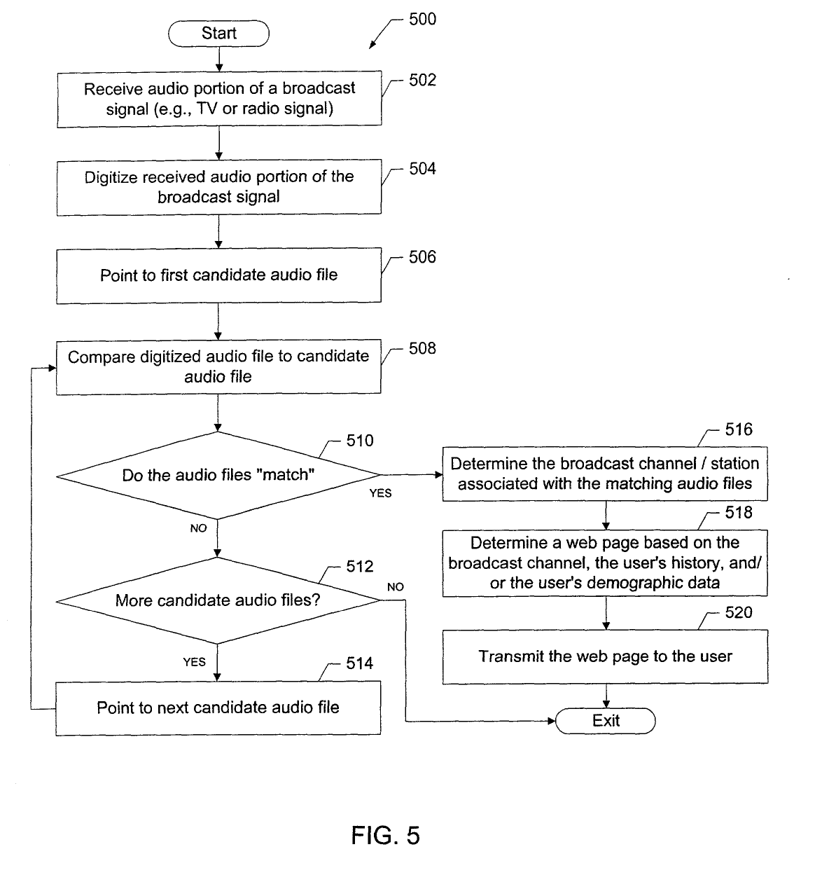

A flowchart of a process 500 for transmitting a web page to a user based on the “normal” audio portion of a broadcast signal is illustrated in FIG. 5. Preferably, the process 500 is executed by one or more of the devices illustrated in FIG. 1. However, one or more of the steps described below may be performed manually. Generally, the process 500 makes a comparison between the sound received by a microphone and sound data indicative of current audio segments associated with a plurality of radio and/or television channels. A broadcast channel can then be determined, and a target web site may be identified. Subsequently, the microphone equipped device (e.g., a PC 104) may be directed to an existing web page or a dynamically generated web page (e.g., a web page based on the determined channel, the users viewing history, and/or the user's demographics). Although audio signals are used in this example, a person of ordinary skill in the art will readily appreciate that video signals may be similarly used.

The process 500 begins by receiving audio signals from a broadcast reception device 106 such as a radio or television (step 502). The audio signals are then digitized in a well known manner (step 504). Subsequently, the process 500 searches for a similar audio file already associated with a known broadcast channel. For example the process 500 may search through the current audio of all television channels transmitted in the users area. Specifically, the process 500 initializes a pointer to point to a first candidate audio file (step 506). The digitized audio file is then compared to the candidate audio file in a well known manner (step 508). If the files do not “match” (step 510), the process checks if there are more candidate audio files to check (step 512). If there are more candidate files, the process 500 points to the next candidate file (step 514) and loops back to step 508.

A “match” need not be an exact match, just more similar than other comparisons or above a certain predetermined threshold. If a match is found (step 510), the process 500 determines the broadcast channel associated with the matching audio files by referencing a lookup table indexed by the candidate audio file pointer (step 516). Subsequently, the process 500 determines a web page based on the broadcast channel, the user's history, and/or the user's demographic data (step 518). For example, if the user is watching a baseball game, the current batter's personal web page may be retrieved. Similarly, an advertisement for tickets to a baseball game may be generated. Finally, the web page may be transmitted to the user in a well known manner (step 520). Preferably, if the PC 104 determines the web page, the PC 104 may simply request the web page. However, if the server 102 determines the web page, the server 102 preferably sends a redirection message to the PC 104, and then the PC 104 requests the web page in response to receiving the redirection message.

In addition, the microphone 313 may be used to detect voice commands from the user. For example, the user may say “show me more” to call a list of choices related to the current broadcast. Subsequently, the user may say “show me number three” to call up a web page detailing the third choice in the list. Over time, choices made by a particular voice may be used to profile the voice. In addition, the person associated with the voice may enter profile information such as age, sex, likes, dislikes, etc. This voice based profile may then be used to narrow the file search process. For example, a parent and a child may be watching the same movie. If the parent says, “Where can I buy that car?, the web page may be for an automobile dealer. Conversely, if the child says, “Where can I buy that car?, the web page may be for a toy store.

In one embodiment, the user's physical location may be determined by “matching” the received audio to audio broadcast only in a certain geographical region. In some embodiments, the file search process may be narrowed based on this geographical determination and/or other geographical identifiers entered by the user (e.g., a zip code). Subsequently, any web page transmitted to the user may be based on the user's physical location.

In summary, persons of ordinary skill in the art will readily appreciate that a method and apparatus for activating a web site based on broadcast radio or television programming has been provided. Systems implementing the teachings described herein can utilize web pages related to television and radio programming without the need for inserted tones or embedded codes.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of exemplary embodiments, but rather by the claims appended hereto.

What is claimed is:

1. A method of retrieving a web page associated with a television broadcast channel, the method comprising the steps of:
receiving a current audio segment of a television broadcast signal, the current audio segment being intended for use by a human recipient in conjunction with a video portion of the television broadcast signal;
comparing the current audio segment to a plurality of candidate audio segments to determine a particular audio segment which represents the current audio segment, the particular audio segment being one of the plurality of candidate audio segments;
correlating the particular audio segment to the television broadcast channel;
determining the web page based on the television broadcast channel; and
retrieving the web page.

2. A method as defined in claim 1, wherein the step of receiving a current audio segment of a television broadcast signal comprises the step of receiving the current audio segment at a microphone operatively coupled to a computing device, wherein the computing device performs the step of retrieving the web page.

3. A method as defined in claim 1, wherein the step of receiving a current audio segment of a television broadcast signal comprises the step of receiving the current audio segment at an audio jack operatively coupled to a computing device, wherein the computing device performs the step of retrieving the web page.

4. A method as defined in claim 2, wherein the step of receiving a current audio segment of a television broadcast signal further comprises the steps of digitizing the current audio segment to generate a captured data file and storing the captured data file in a memory associated with the personal computer.

5. A method as defined in claim 1, wherein the step of receiving a current audio segment of a television broadcast signal comprises the step of receiving the current audio segment via a wire operatively coupled to television and a personal computer, wherein the personal computer performs the step of retrieving the web page.

6. A method as defined in claim 5, wherein the step of receiving a current audio segment of a television broadcast signal further comprises the step s of digitizing the current audio segment to generate a captured data file and storing the captured data file in a memory associated with the computing device.

7. A method as defined in claim 1, further comprising the step of receiving the plurality of candidate audio segments at a computing device via the Internet, wherein the step of comparing the current audio segment to the plurality of candidate audio segments comprises the step of comparing the current audio segment to the plurality of candidate audio segments at the computing device.

8. A method as defined in claim 1, further comprising the step of transmitting the current audio segment to a server via the Internet, wherein the step of comparing the current audio segment to the plurality of candidate audio segments comprises the step of comparing the current audio segment to the plurality of candidate audio segments at the server.

9. A method as defined in claim 1, wherein the plurality of candidate audio segments is associated with a plurality of television broadcast channels.

10. A method as defined in claim 1, further comprising the step of recording a time stamp associated with the current audio segment, wherein the step of comparing the current audio segment to a plurality of candidate audio segments comprises the step of comparing the time stamp associated with the current audio segment to a time stamp associated with the particular audio segment from the plurality of candidate audio segments.

11. A method as defined in claim 1, wherein the step of determining the web page based on the television broadcast channel further comprises the step of determining the web page based on a television viewing history.

12. A method as defined in claim 1, wherein the step of determining the web page based on the television broadcast channel further comprises the step of determining the web page based on a user's demographics.

13. A method as defined in claim 1, further comprising the step of receiving a redirection message via the Internet, wherein the step of retrieving the web page is performed in response to the step of receiving the redirection message.

14. A method as defined in claim 1, wherein the web page is a web page which existed prior to the step of receiving a current audio segment.

15. A method as defined in claim 1, wherein the web page is a web page which is dynamically generated after the step of correlating the particular audio segment to the television broadcast channel.

16. A method as defined in claim 1, wherein the web page is a web page which is associated with the television broadcast channel by a sponsor.

17. A method as defined in claim 1, wherein the television broadcast channel is transmitted via at least one of a radio wave, a cable signal, and a web-cast.

18. A method as defined in claim 1, further comprising the step of determining a geographic location associated with the particular audio segment.

19. A method as defined in claim 18, wherein the step of determining the web page comprises the step of determining the web page based on the geographic location.

20. A method as defined in claim 1, further comprising the steps of:
receiving a voice command; and
determining a user profile associated with the voice command, wherein the step of determining the web page comprises the step of determining the web page based on the user profile.

21. A method of retrieving a web page associated with a radio station, the method comprising the steps of:
receiving a current audio segment of a radio broadcast signal during a time period;
comparing the current audio segment to a plurality of candidate audio segments associated with the time period to determine a particular audio segment which represents the current audio segment, the particular audio segment being one of the plurality of candidate audio segments;
correlating the particular audio segment to the radio station;
determining the web page based on the radio station; and
retrieving the web page.

22. A method as defined in claim 21, wherein the radio broadcast signal is transmitted via at least one of a radio wave, a cable signal, and a web-cast.

23. A method as defined in claim 21, wherein the step of receiving a current audio segment of a radio broadcast signal comprises the step of receiving the current audio segment at a microphone operatively coupled to a computing device, wherein the computing device performs the step of retrieving the web page.

24. A method as defined in claim 21, wherein the step of receiving a current audio segment of a radio broadcast signal comprises the step of receiving the current audio segment at an audio jack operatively coupled to a computing device, wherein the computing device performs the step of retrieving the web page.

25. A method as defined in claim 21, further comprising the step of receiving the plurality of candidate audio segments at a computing device via the Internet, wherein the step of comparing the current audio segment to the plurality of candidate audio segments comprises the step of comparing the current audio segment to the plurality of candidate audio segments at the computing device.

26. A method as defined in claim 20, further comprising the step of transmitting the current audio segment to a server via the Internet, wherein the step of comparing the current audio segment to the plurality of candidate audio segments comprises the step of comparing the current audio segment to the plurality of candidate audio segments at the server.

27. A method as defined in claim 21, further comprising the step of determining a geographic location associated with the particular audio segment.

28. A method as defined in claim 27, wherein the step of determining the web page comprises the step of determining the web page based on the geographic location.

29. A method as defined in claim 21, further comprising the steps of:
receiving a voice command; and
determining a user profile associated with the voice command, wherein the step of determining the web page comprises the step of determining the web page based on the user profile.

30. A computer readable medium storing a software program for retrieving a web page associated with an audio broadcast, the software program being structured to cause a computing device to:
receive a current audio segment of the audio broadcast during a time period, the current audio segment being intended for use by a human recipient;
compare the current audio segment to a plurality of candidate audio segments associated with the time period to determine a particular audio segment which represents the current audio segment, the particular audio segment being one of the plurality of candidate audio segments;
determine the web page based on the particular audio segment; and
retrieve the web page.

31. A computer readable medium as defined in claim 30, wherein the software program is further structured to cause the computing device to:
transmit data indicative of the current audio segment to a server via the Internet; and
transmit a demographic identification signal to the server via the Internet.

32. A method of retrieving a web page associated with a television broadcast channel, the method comprising the steps of:
receiving a current video segment of a television broadcast signal;
comparing the current video segment to a plurality of candidate video segments to determine a particular video segment which represents the current video segment, the particular video segment being one of the plurality of candidate video segments;
correlating the particular video segment to the television broadcast channel;
determining the web page based on the television broadcast channel; and
retrieving the web page.

33. A method as defined in claim 32, wherein the step of receiving a current video segment of a television broadcast signal comprises the step of receiving the current video segment at a video jack operatively coupled to a computing device, wherein the computing device performs the step of retrieving the web page.

34. A method as defined in claim 32, further comprising the step of receiving the plurality of candidate video segments at a computing device via the Internet, wherein the step of comparing the current video segment to the plurality of candidate video segments comprises the step of comparing the current video segment to the plurality of candidate video segments at the computing device.

35. A method as defined in claim 32, further comprising the step of transmitting the current video segment to a server via the Internet, wherein the step of comparing the current video segment to the plurality of candidate video segments comprises the step of comparing the current video segment to the plurality of candidate video segments at the server.

36. A method as defined in claim 32, further comprising the step of recording a time stamp associated with the current video segment, wherein the step of comparing the current video segment to a plurality of candidate video segments comprises the step of comparing the time stamp associated with the current video segment to a time stamp associated with the particular video segment from the plurality of candidate video segments.

37. A method as defined in claim 32, wherein the step of determining the web page based on the television broadcast channel further comprises the step of determining the web page based on a television viewing history.

38. A method as defined in claim 32, wherein the step of determining the web page based on the television broadcast channel further comprises the step of determining the web page based on a user's demographics.

39. A method as defined in claim 32, further comprising the step of receiving a redirection message via the Internet, wherein the step of retrieving the web page is performed in response to the step of receiving the redirection message.

40. A method as defined in claim 32, wherein the web page is a web page which is associated with the television broadcast channel by a sponsor.

41. A method as defined in claim 32, further comprising the step of determining a geographic location associated with the particular video segment.

42. A method as defined in claim 41, wherein the step of determining the web page comprises the step of determining the web page based on the geographic location.

43. A method as defined in claim 32, further comprising the steps of:
receiving a voice command; and
determining a user profile associated with the voice command, wherein the step of determining the web page comprises the step of determining the web page based on the user profile.
